(19) United States
(12) Patent Application Publication
(10) Pub. No.: US 2017/0175613 A1
(43) Pub. Date: Jun. 22, 2017

(54) THERMOSTAT STABILITY ENHANCEMENT VIA WAVY VALVE PLATE

(71) Applicant: GM Global Technology Operations LLC, Detroit, MI (US)

(72) Inventors: Michael POISSON, Farmington Hills, MI (US); Rolf B. KARLSSON, Grand Blanc, MI (US); William C. SAINDON, Goodrich, MI (US); Jan Andrzej GATOWSKI, Beverly Hills, MI (US); Dennis S. DICKTY, Shelby Township, MI (US)

(21) Appl. No.: 14/970,593

(22) Filed: Dec. 16, 2015

(51) Int. Cl. F01P 7/16; G05D 23/185

(52) U.S. Cl. CPC F01P 7/165; G05D 23/1852

(57) ABSTRACT

A thermostat for use in the coolant passage of an internal combustion engine includes a valve seat and a valve plate with an elastomeric seal engaged with the valve seat in a closed condition and movable away from the valve seat in an open condition. The valve plate has a wavy surface disposed below the elastomeric seal that engages the valve seat, wherein the wavy surface is nonplanar with surface variations of at least 300 microns. The wavy valve plate creates a situation where the thermostat operates with two effective modes, a low flow regime for low load conditions where the valve is only traveling between 0 and approximately 1 mm while the wavy plate allows a low coolant flow and a high flow regime (valve fully open) for high engine load situations that require maximum cooling.

### FIELD

The present disclosure relates to thermostats for use with internal combustion engines, and more particularly to a thermostat having a wavy valve plate.

### BACKGROUND AND SUMMARY

This section provides background information related to the present disclosure which is not necessarily prior art.

Internal combustion engines typically employ a cooling system for maintaining the engine within a desired operating temperature range. The cooling system for many automotive vehicles employs a coolant fluid that is circulated through the cylinder block and cylinder head of the engine and through a radiator. A thermostat is used to regulate the flow of coolant to the radiator so as to maintain the coolant at a desired temperature. Engine outlet side thermostats have historically been problematic with regards to control at low load conditions. In modern systems this can cause the thermostat to continuously open and close at steady state highway speeds. The result is that the radiator can be continuously exposed to thermal cycles to the point where the tubes fatigue and may leak.

The present disclosure provides a thermostat disposed in the coolant passage and including a valve seat and a valve plate engaged with the valve seat in a closed condition and movable away from the valve seat in an open condition, the valve plate having a wavy surface, wherein the wavy seat surface is nonplanar with surface variations of at least 300 microns. The edge of the wavy valve plate contains an elastomeric seal which engages the seat. The wavy valve plate creates a situation where the thermostat operates with two effective control regimes, a fine control for low load conditions where the valve is only traveling between 0 and approximately 1 mm while the wavy plate allows a low coolant flow, and a high flow regime (valve fully open) for high engine load situations that require maximum cooling. In contrast, the flat valve plate designs only have a coarse flow control regime for low load condition and are unable to control radiator flow during low load.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an internal combustion engine having a cooling system with a thermostat according to the principles of the present disclosure;

FIG. 2 is a cross-sectional view of an exemplary thermostat according to the principles of the present disclosure;

FIG. 3 is a schematic view of a wavy thermostat valve plate according to the principles of the present disclosure; and

FIG. 4 is a schematic illustration of the deformation of the wavy thermostat valve plate according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

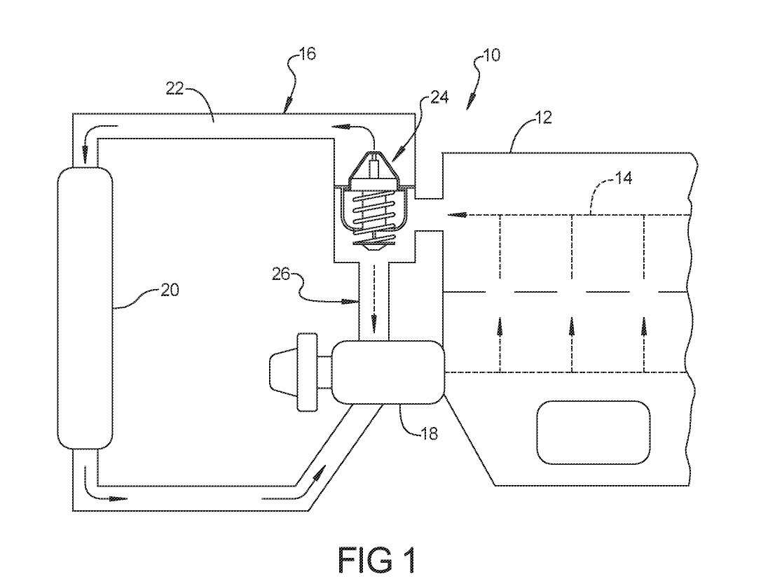

With reference to FIG. 1, an engine assembly 10 is shown including an internal combustion engine 12 that define a plurality of combustion chambers that can be in the form of combustion cylinders. The internal combustion engine 12 can include a cylinder block and a cylinder head with engine coolant passages 14 extending there through for maintaining the engine 12 at an appropriate operating temperature. The engine assembly 10 also includes a cooling system 16 that includes a water pump 18 for pumping a coolant fluid through the cooling system 16 and the engine coolant passages 14 Cooling system 16 further includes a radiator 20 connected to the water pump 18 by a coolant passage 22. A thermostat 24 is provided in the coolant passage 22 and is operable in an open condition to allow coolant flow through the radiator 20 and in a closed condition for preventing the flow of coolant through the radiator 20. The cooling system 16 can include a bypass passage 26 to allow the coolant to return to the water pump 18 and bypass the radiator 20 when the thermostat 24 is closed.

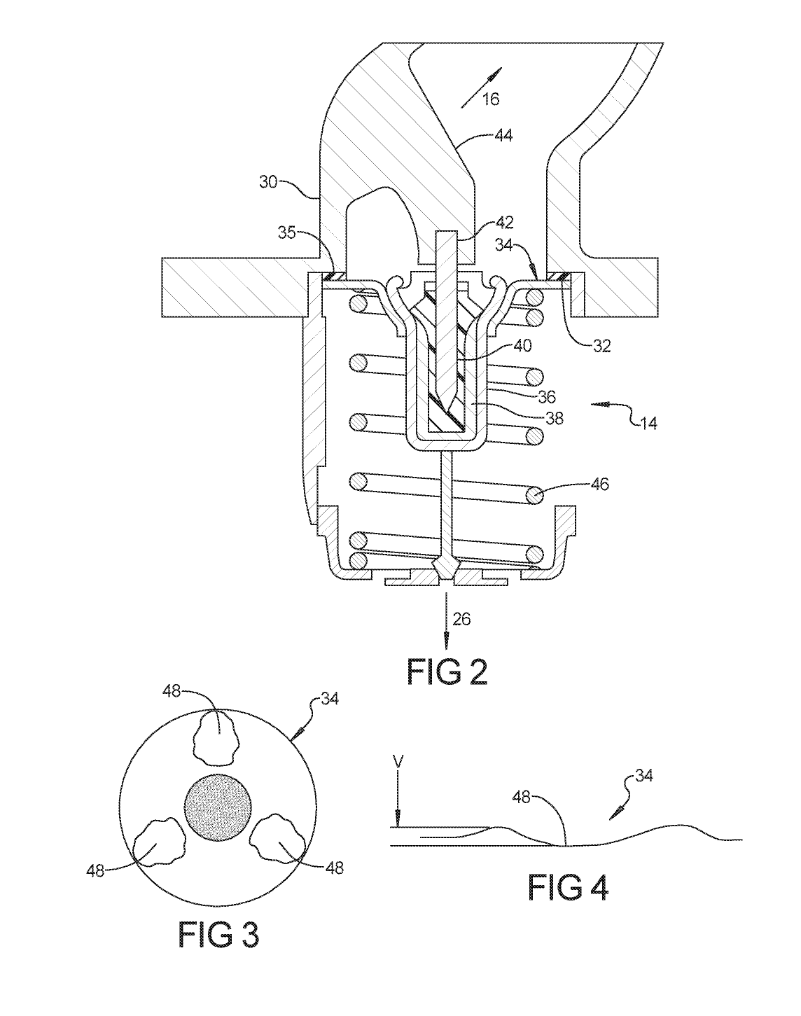

With reference to FIG. 2, an exemplary thermostat 24 will now be described. The thermostat 24 can include a base 30 defining a valve seat 32. A valve plate 34 contains an elastomeric seal 35 and is seated against the valve seat 32 in the closed position and is movable away from the valve seat 32 in an open position. The valve plate 34 can be connected to a case 36 that houses a wax pellet 38 that surrounds a rubber body 40 disposed around a piston 42. The piston 42 is fixedly mounted to a support structure 44 of the base 30. A spring 46 is disposed against the valve plate 34 to bias the valve plate 34 against the spring seat 32.

In operation, as the coolant within the engine 12 heats up, the coolant heats the wax pellet 38. As the wax pellet 38 melts, it expands and presses against the rubber body 40 and causes the case 36 to be pushed in a downward direction as depicted in FIG. 2. The movement of the case 36 causes the valve plate 34 to be disengaged from the valve seat 32 so that coolant can flow through the thermostat 24to the radiator 20.

According to the principles of the present disclosure, the valve plate 34 is formed with a wavy configuration as shown in FIG. 3 to include one or more deformed low spots 48. As shown in FIG. 4, the deformed low spots 48 have a surface variation “V” in a range of from 300 to 450 microns. The wavy surface provides a backing for the elastomeric seal 35. The wavy valve plate creates a situation where the thermostat operates with two effective controls regimes, fine control regime for low load conditions where the valve is only traveling between 0 and approximately 1 mm while the wavy plate allows a low coolant flow and a high flow regime (valve fully open) for high engine load situations that require maximum cooling. The fine control condition is achieved by the wax pellet 38 partially expanding and a steady state condition being achieved wherein the low coolant flow created by the slight movement of the wavy valve plate 34 maintains the coolant temperature at a level that maintains the partial expansion of the wax pellet 38 and slight opening of the valve plate 34. In contrast, the conventional flat valve plate designs only have coarse flow control in this condition and are unable to control radiator flow during low load.

As compared to conventional thermostat valve plates that have a planar engagement surface, it has been discovered that the wavy valve plate configuration creates a situation where the thermostat 24 can regulate small amounts of flow during initial opening of the valve plate 34, resulting in an improved flow control as compared to a conventional flat plate design. The fine flow control during initial opening of the valve plate allows the thermostat 24 to be placed further away from the radiator 20 and provides a situation where the thermostat 24 can adjust the flow to a lower steady state value. In particular, the wavy valve plate 34 creates a situation where the thermostat operates with two effective flow regimes, a fine control regime for low load conditions where the valve plate 34 is only traveling between 0 and approximately 1 mm while the wavy plate 34 allows a low coolant flow, and a high flow regime (valve fully open) for high engine load situations that require maximum cooling. In contrast, the flat valve plate designs only has coarse flow control at low flows and is unable to control radiator flow during low load.

Although the wavy valve plate 34 of the present disclosure is described with a thermostat having a particular configuration, it should be understood that the wavy valve plate can be used with other known thermostat configurations. By way of example, the thermostat 24 of the present disclosure includes the valve plate 34 being connected to the case 36 and the piston 42 is fixed to the base 30, while other known thermostats include a valve plate fixed to a movable piston and a case that is fixed to the base in which the wavy valve plate could also be used without departing from the principles of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An engine cooling system, comprising:
an engine including internal coolant passages therein;
a radiator in communication with the internal coolant passages via additional coolant passages; and
a thermostat disposed in at least one of the internal coolant passages and the additional coolant passages, the thermostat including a valve seat and a valve plate with an elastomeric seal engaged with the valve seat in a closed condition and movable away from the valve seat in an open condition, the valve plate having a wavy surface below the elastomeric seal.

2. The engine cooling system according to claim 1, wherein the wavy surface is nonplanar with surface variations of at least 300 microns within the wavy surface.

3. The engine cooling system according to claim 1, wherein the wavy surface is nonplanar with a plurality of low spots on the seat engagement surface.

4. The engine cooling system according to claim 3, wherein the plurality of low spots have surface variations of at least 300 microns.

5. The engine cooling system according to claim 1, wherein the valve plate is connected to a case that houses a wax pellet.

6. A thermostat for use in a coolant system of an internal combustion engine, comprising:
a base that defines a valve seat;
a wax cavity and a piston operatively engaged with the wax cavity; and
a valve plate engaged with one of the wax cavity and the piston and the other of the wax cavity and the piston being fixed to the base, the valve plate being engaged with the valve seat in a closed condition and movable away from the valve seat in an open condition, the valve plate having a wavy seat engagement surface disposed below an elastomeric seal that engages the valve seat.

7. The thermostat according to claim 6, wherein the wavy seat engagement surface is nonplanar with surface variations of at least 300 microns within the wavy seat engagement surface.

8. The thermostat according to claim 6, wherein the wavy seat engagement surface is nonplanar with a plurality of low spots on the seat engagement surface.

9. The thermostat according to claim 8, wherein the plurality of low spots have surface variations of at least 300 microns.

10. The thermostat according to claim 6, wherein the valve plate is connected to a case that houses a wax pellet.

11. A thermostat for use in a coolant system of an internal combustion engine, comprising:
a base that defines a valve seat;
a wax cavity and a piston operatively engaged with the wax cavity; and
a valve plate engaged with one of the wax cavity and the piston and the other of the wax cavity and the piston being fixed to the base, the valve plate being engaged with the valve seat in a closed condition and movable away from the valve seat in an open condition, the valve plate having a nonplanar seat engagement surface disposed below a seal element that engages the valve seat.

12. The thermostat according to claim 11, wherein the nonplanar seat engagement surface includes surface variations of at least 300 microns within the nonplanar seat engagement surface.

13. The thermostat according to claim 11, wherein the nonplanar seat engagement surface includes a plurality of low spots on the seat engagement surface.

14. The thermostat according to claim 13, wherein the plurality of low spots have surface variations of at least 300 microns.

15. The thermostat according to claim 11, wherein the valve plate is connected to a case that houses a wax pellet.
